(19) United States
(12) Patent Application Publication
(10) Pub. No.: US 2005/0032234 A1
(43) Pub. Date: Feb. 10, 2005

(54) Integrated test cup

(76) Inventor: James T. Ramsey, Virginia Beach, VA (US)

Correspondence Address: Jeffrey K. Seto, 406 Riverland Dr., #1, Salem, VA, 24153, US

(21) Appl. No.: 10/911,264

(22) Filed: Aug. 4, 2004

Related U.S. Application Data
(60) Provisional application No. 60/491,699, filed on Aug. 4, 2003.

(51) Int. Cl. G01N 21/00

(52) U.S. Cl. 436/169; 422/58

(57) ABSTRACT

An improved apparatus and method for conducting and recording tests on a sample of urine. A large sample collection cup is provided with a testing compartment incorporated into the side of the cup. A small channel at the base of the cup allows urine to flow into the testing compartment immediately upon collection. A test card with pretreated reaction sites is provided inside the testing compartment. At least a portion of the sample interacts with the test card and the results of the test can be read through the front of the testing compartment. Abbreviations on the test card indicate which tests are being run. The front of the testing compartment is flat so the results of the test can be easily photocopied or scanned for record keeping purposes. Physical and electronic templates are also provided to aid in the documentation process.

### BACKGROUND OF THE INVENTION

This application was originally filed as provisional U.S. patent application, No. 60/491,699, with a filing date of Aug. 4, 2003. Priority is hereby claimed to this provisional patent application.

The present invention relates generally to the field of urine testing and more specifically to a sample collection cup with an integrated testing system.

Drug screen tests are well known in the personnel offices of businesses around the world. Employers commonly require tests for drugs of abuse such as cocaine and heroin and these tests have become an ordinary part of job applications. In the sports world, it is also common to test athletes for performance enhancement drugs such as certain steroids. Dipsticks that have been treated with chemicals that react to by-products of specified drugs can be dipped into a urine sample from the job applicant or athlete to provide onsite testing. Test cards are cards that have had multiple sites on the card chemically treated so that multiple drugs can be tested for simultaneously. Test cards, which are approximately the size of a business card, are used in the same manner as dip sticks, i.e., testing is traditionally conducted by dipping the card into a urine sample, waiting a specified period of time and then reading the indication sites on the card.

In a traditional drug screen test, a sample provider deposits a urine sample into a collection cup, places a lid on the cup and then places a piece of tape over the lid so that the tape extends down over the lid and onto the cup. This piece of tape is intended to insure that no other substance is added to the urine sample prior to testing. The sample provider then hands the sealed collection cup to a test administrator. In order to gain access to the urine sample, the test administrator must break the seal that secures the lid to the top of the collection cup. At this point it is possible for other substances to fall, accidentally or otherwise, into the collection cup and taint the sample. The addition of foreign substances to the sample can cause false or invalid test results.

What is needed in the field is an apparatus that provides for collection and testing of a sample all in one step so there is no need to break the security seal placed on the cup by the sample provider. An ideal apparatus would also allow for photocopying or scanning of the test results to facilitate record keeping. Photocopy machines are machines that make a reproduction of an original by taking a picture of the original and printing the reproduction on a sheet of paper. Scanners are machines the make a digital representation of an original and store the digital representation on a storage medium, such as the hard drive of a personal computer. At some later time, the digital representation of the original can be printed by a printer connected to the personal computer.

### SUMMARY OF THE INVENTION

A test cup with an integrated test card and recordation system for collecting a sample of urine, immediately initiating a test on the collected sample and directly recording, by photocopying or scanning, the results of the test after administration. The integrated test cup includes a cup with a general cylindrical shape, the cup has a solid bottom, an open top, and a cylindrical wall. A testing compartment is attached to the outside of the cylindrical wall. The testing compartment has a flat front that facilitates photocopying and electronic scanning of the front of the testing compartment. The back of the testing compartment has a shape that conforms to the shape of the exterior of the cup. A channel that defines an opening between the bottom of the cup and the testing compartment is provided so that the sample is allowed to flow from the cup into the testing compartment. A test card with multiple reaction sites is located inside the testing compartment. The reaction sites visibly indicate whether or not specified chemicals are present in the sample. The reaction sites on the test card can be seen through the front of the testing compartment.

The test card may include a wick that aids in the flow of the sample to the reaction sites of the test card. A lid is also provided that can be secured to the top of the cup so that a watertight seal is created between the lid and the top of the cup. The present test cup has an associated template that includes relevant information pertaining to the test subject and the test administrator. The template includes a blank window that is filled with a reproduction of the front of the testing compartment, and thus the test results, after test administration. If a photocopying machine is used for reproduction of the test results, then a paper template is provided. If a scanner is used to document the test results, then an electronic template is provided.

The test card preferably includes indications, including abbreviations, next to each reaction site indicating what drug/chemical is being tested for at the sites. The test card may also include at least one adulteration site, the adulteration site being designed to indicate when a foreign substance has been added to the sample of urine. Instructions for using the present test cup can be provided either on the test cup or on the template, or on both. The front of the testing compartment can also include a privacy label that prevents viewing of the reaction sites on the test card. The privacy label can be peeled away later by the administrator to allow viewing of the reaction sites.

The test cup also preferably includes a security seal, such as foil tape, that can be placed over the lid and two sides of the cup, after the sample has been deposited in the cup. After the security seal has been applied, the lid cannot be removed without breaking the security seal. Thus, the security seal provides positive evidence as to whether or not the lid has previously been removed. A thermometer is also provided on the exterior of the cup, near the bottom, so the test administrator can check the temperature of the sample and insure that the temperature is within an acceptable range. The test card can be manufactured to indicate the presence of drugs of abuse including, cocaine, marijuana, amphetamines, meth-amphetamines, opiates/morphine, phencyclidine, benzodiazepine, barbiturates, methadone and tri-cyclic antidepressants.

It is an object of the present invention to provide an improved apparatus for collecting and testing urine samples and an improved method for directly recording the results shown on the apparatus along with other pertinent information regarding the test, the donor and the administrator.

### BRIEF DESCRIPTION OF THE DRAWINGS

The invention of the present application will now be described in more detail with reference to the accompanying drawings, given only by way of example, in which:

FIG. 1 is a frontal perspective view of the present integrated test cup;

FIG. 2 is a front view of the integrated test cup with the privacy label peeled back;

FIG. 3 is another front view of the integrated test cup with the privacy label peeled back;

FIG. 4 shows a template for recording the results of a test; and,

FIG. 5 is a flow chart showing steps for using the present integrated test cup and template.

### DETAILED DESCRIPTION OF THE INVENTION

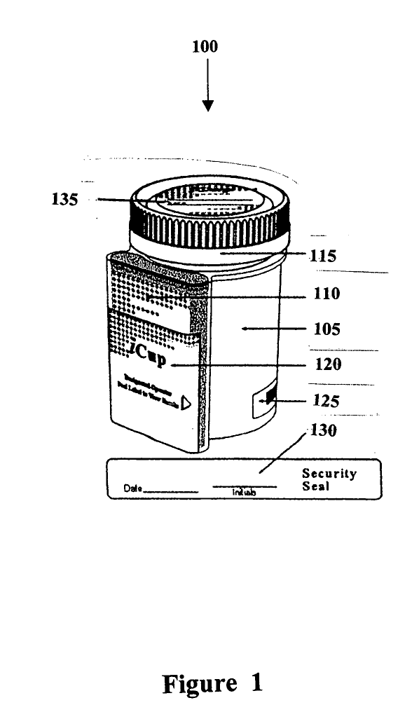

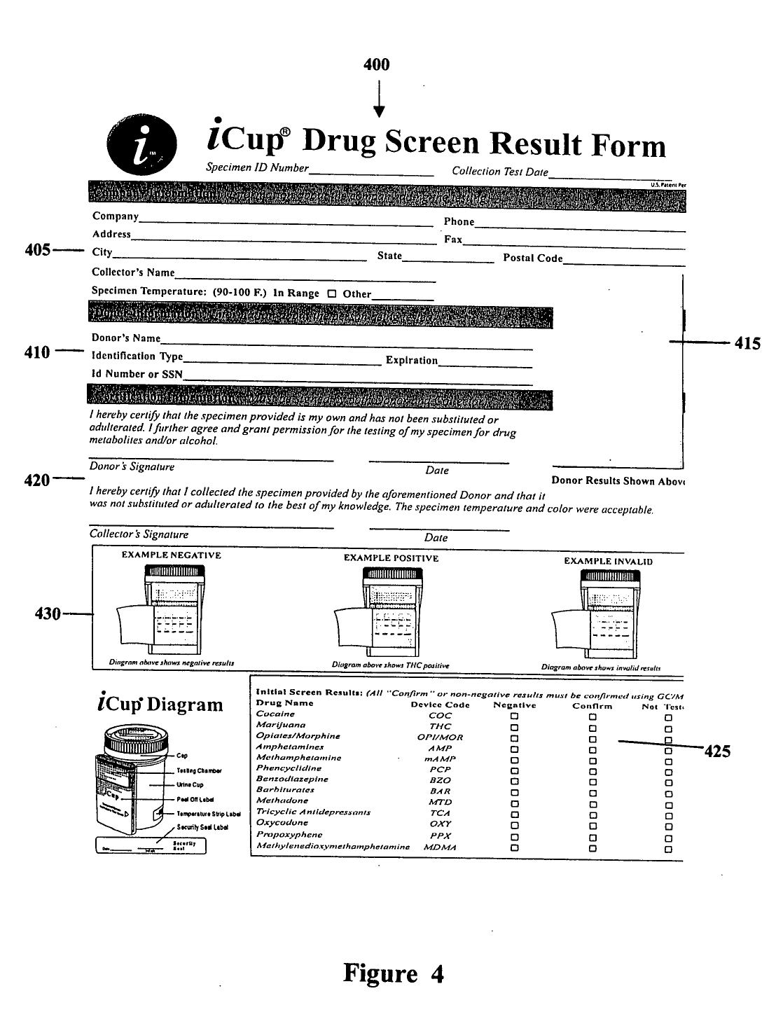

FIG. 1 shows the preferred embodiment of the present integrated test cup 100. The present invention provides an improved urine sample collection cup 105 that allows for instantaneous testing upon collection. The collection cup 105 has a wide opening at the top and a capacity large enough to allow the cup 105 to act as the primary collection device, meaning no transfer of the sample is needed prior to testing. A lid 115 is provided to securely seal the cup 105 after collection. One side of the collection cup 105 has incorporated therein a testing compartment 110. The testing compartment 110 houses a test card with chemically treated reaction sites that begins to react with the sample almost immediately upon collection. After the donor is finished providing the sample, the donor seals the cup 105 with the lid 115. The donor then preferably places a security seal 130 across the top of the lid so that the seal extends past the lid and touches opposite sides of the cup 105. If anyone removes the lid from the cup at a later time the security seal will be broken. The provider then hands the integrated test cup 100 to a test administrator. Typically, by the time the collection cup reaches an administrator, approximately sixty seconds, the results of the test are ready to be read. A privacy label 120 is peeled away from the front of the testing compartment 110 to reveal the results of the test. The results are read through the front of the testing compartment, which is advantageously designed to be flat so the results can be scanned or photocopied for easy documentation. Photocopy templates and electronic templates are provided and discussed further in conjunction with FIG. 4. A thermometer 125 is provided near the bottom of the collection cup so that the temperature of even a small amount of sample can be taken. An immediate reading of the temperature by the test administrator helps insures that a true sample was provided by the donor. In the preferred embodiment, the lid 115 also includes an area on top to write information 135 regarding the donor and the test.

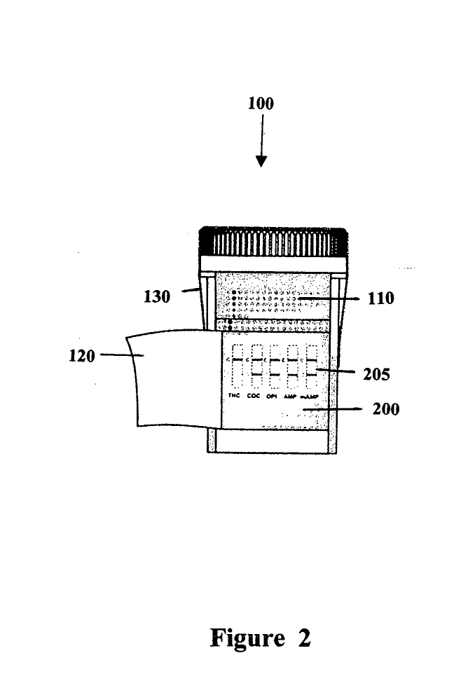

FIG. 2 shows a front view of the integrated test cup 100 with the privacy label 120 peeled back from the front of the test compartment 110 so that the test card 200 and the reaction sites 205 on the test card can be seen. FIG. 2 also shows the security seal 130 in operational position. FIG. 2 is an example of a test in which the results indicate a positive indication for the use of marijuana (THC). While the preferred embodiment is used for drug screen tests, the present invention can also be used for any test run on a urine sample, including pregnancy testing.

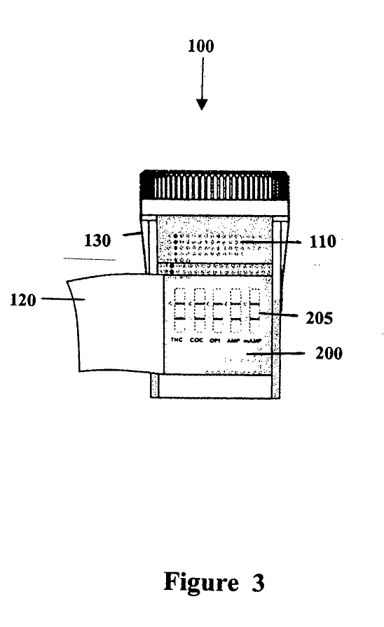

FIG. 3 also shows a front view of the integrated test cup 100 with the privacy label 120 peeled back from the front of the test compartment 110 so that the test card 200 and the reaction sites 205 on the test card can be seen. The security seal 130 is again shown in its operational position. FIG. 3 is an example of a test in which the results indicate negative for all tested chemicals.

FIG. 4 shows the template 400 that is provided with the preferred embodiment. The template 400 includes: a section for information about the company administering the test 405; a section for information about the donor 410; a blank window 415 into which a reproduction of the front of the testing compartment is placed either by photocopying or scanning; a certification section 420 that includes spaces for signatures from the donor and the test administrator; a legend and “check the block” area 425 that provides a legend for the codes used on the test card and a space for the administrator to checkmark which tests were run and the results of each; and, a window 430 that provides pictorial examples of positive, negative and invalid results.

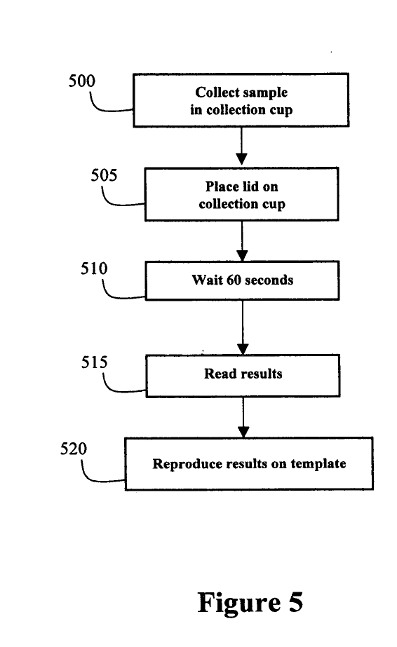

FIG. 5 is a flow chart showing the steps of the preferred method. In step 500, the donor provides the sample directly into the collection cup. In step 505, the donor places the lid on the cup. The lid and cup preferably have complementary threads and the lid includes a washer so that when the lid is screwed onto the top of the cup a watertight seal is provided. In an alternate embodiment, after the lid is secured the donor then places a security seal over the lid and the sides of the cup to prevent tampering. In step 510, at least sixty seconds is allowed to pass so that the test card has sufficient time to react with the sample. Typically, by the time the donor is ready to transfer the integrated collection cup to the test administrator sufficient time has passed and the results are ready to be read, step 515. If a privacy label is provided over the front of the testing compartment, then an additional step of peeling off the privacy label is required prior to reading the results. In step 520, the front of the testing compartment is placed against a photocopy machine or a scanner and the results of the test (the reaction sites on the test card) are reproduced on a template that includes information regarding the test, the donor and the administrator. If a photocopy machine is used for reproduction, then a physical template such as paper or linen, is used. If a scanner is used for reproduction, then an electronic template that can be stored in the memory of a personal computer is used.

The present testing system can be used to detect many different chemicals in a urine specimen. In the preferred embodiment, the test card is designed to detect whether or not the person being tested has used drugs of abuse. However, the device can also test for other medical conditions as well, such as pregnancy. In the preferred embodiment, the test card is manufactured to detect cocaine, amphetamines, THC, opiates, or PCP. In alternative embodiments, other drugs of abuse are tested for and at least one of the test pads 109 detects contaminants in the sample that interfere with the testing process.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

1. A test cup with an integrated test card and recordation system for collecting a sample of urine, immediately initiating a test on the sample and facilitating direct recording of a result of the test, the system comprising:
a cup with a general cylindrical shape, the cup having a solid bottom, an open top, and a cylindrical wall extending from the solid bottom of the cup to the open top of the cup;
a testing compartment that is attached to an exterior side of the cylindrical wall, the testing compartment having a front and a back, wherein the front has a flat surface that facilitates photocopying and electronic scanning of the front of the testing compartment, and the back of the testing compartment has a shape that conforms to a shape of the exterior side of the cup's cylindrical wall;
a channel that defines an opening between the cup and the testing compartment so that at least a portion of the sample is allowed to flow from the cup into the testing compartment, the channel being provided through the cylindrical wall at a point near the solid bottom of the cup;
a test card that is located inside the testing compartment, the test card containing multiple reaction sites that react with specified chemicals in the urine sample, the reaction sites being able to visibly indicate whether or not the specified chemicals are present in the sample, wherein the reaction sites are visible through the front of the testing compartment;
a lid that can be secured to the top of the cup so that a watertight seal is created between the lid and the top of the cup; and,
a template that includes relevant information pertaining to a test subject and a test administrator and also includes a blank window, the blank window being large enough for the placement of a reproduction of the front of the testing compartment.

2. The test cup of claim 1, wherein the template is adapted to be used with a photocopy machine and a photocopy of the front of the testing compartment is placed in the blank window of the template.

3. The test cup of claim 1, wherein the template is an electronic template that is adapted to be used with a personal computer and a scanner and an electronic copy of the front of the testing compartment is placed in the blank window of the template.

4. The test cup of claim 1, further comprising:
a wick that is located at a bottom portion of the testing compartment, the wick having a first end that touches a bottom of the testing compartment and second end that touches the test card, the wick aiding in a flow of the sample to the test card.

5. The test cup of claim 1, wherein an area for writing identification information about a test subject is provided on the test cup.

6. The test cup of claim 1, wherein the test card further includes indications, including abbreviations, next to each reaction site indicating what chemical is being tested for at the sites.

7. The test cup of claim 1, wherein at least one of the reaction sites is an adulteration site, the adulteration site designed to indicate when a foreign substance has been added to the sample of urine.

8. The test cup of claim 1, wherein instructions for using the present test cup are provided either on the test cup or on the template.

9. The test cup of claim 1, wherein the testing compartment includes a privacy label that prevents viewing of the reaction sites on the test card, wherein the privacy label can be peeled away to allow viewing of the reaction sites.

10. The test cup of claim 1, wherein the testing compartment has a height that extends from the bottom of the cup to the top of the cup.

11. The test cup of claim 1, further comprising a security seal, including foil tape, that can be placed over the lid and two sides of the cup, after the sample has been deposited in the cup, so that the lid cannot be removed from the cup without breaking the security seal.

12. The test cup of claim 1, further comprising a thermometer that is provided on an exterior wall of the cup near the bottom of the cup, the thermometer being able to indicate a temperature of the sample.

13. The test cup of claim 1, wherein the test card is manufactured to indicate the presence of drugs of abuse including, cocaine, marijuana, amphetamines, meth-amphetamines, opiates/morphine, phencyclidine, benzodiazepine, barbiturates, methadone and tri-cyclic antidepressants.

14. A method for collecting a urine sample, immediately testing the sample and recording a result of the test on a template, wherein a collection cup with an integrated testing compartment is used, the collection cup and testing compartment having a channel that allows the sample to flow from the cup into the testing compartment, the testing compartment including a test card that absorbs at least a portion of the sample, reacts with specified chemicals in the sample and visibly indicates whether or not the specified chemicals are present in the sample, wherein the visible indications can be seen through a front of the testing compartment, the method comprising the steps of:
collecting the sample in the collection cup by having the sample provider deposit the sample directly into the collection cup;
placing a lid on the collection cup, by the sample provider, after the sample has been deposited in the cup, wherein the lid forms a watertight seal between the lid and the collection cup;
transferring the collection cup to a test administrator;
reading the result of the test by the administrator; and, reproducing the front of the testing compartment on the template, wherein the template includes information about the sample provider and the administrator.

15. The method of claim 14, wherein the step of placing a lid on the collection cup further comprises the step of:
placing a security label over the lid, the security label having two ends, wherein both ends extend past the lid and are adhered to opposite sides of the cup.

16. The method of claim 14, wherein the front of the testing compartment is covered by a privacy label, and the step of reading the results is preceded by the step of:
peeling the security label off of the front of the testing compartment.

17. The method of claim 14, wherein the step of reproducing further comprises the step of:
using a photocopying machine to reproduce the front of the testing compartment on the template.

18. The method of claim 14, wherein the step of reproducing further comprises the step of:
using a scanner to reproduce the front of the testing compartment on the template.

19. The method of claim 14, wherein blank space for information about the sample provider and the test administrator is provided on the collection cup or is provided on the lid.

20. The method of claim 14, wherein the test card is able to detect usage of cocaine, marijuana, amphetamines, meth-amphetamines, opiates/morphine, phencyclidine, benzodiazepine, barbiturates, methadone and tri-cyclic antidepressants by the sample provider and abbreviations are provided on the test card to show which drugs are being test for on the test card.
